(19) United States
(12) Patent Application Publication
(10) Pub. No.: US 2025/0040554 A1
(43) Pub. Date: Feb. 6, 2025

(54) NEW USES OF PHENMEDIPHAM AND HERBICIDAL COMBINATIONS COMPRISING PHENMEDIPHAM

(71) Applicants: BAYER AKTIENGESELLSCHAFT, Leverkusen (DE); BAYER CROPSCIENCE LP, St. Louis, MO (US)

(72) Inventors: Lothar LORENTZ, Leverkusen (DE); Sabine STOLZ, St. Louis, MO (US); Volker KÜHNHOLD, Leverkusen (DE); Catherine Marie DE VULDER, Leverkusen (DE); Udo BICKERS, Leverkusen (DE); Herve TOSSENS, St. Louis, MO (US); Andrea MAAS, St. Louis, MO (US)

(21) Appl. No.: 18/717,656

(22) PCT Filed: Dec. 8, 2022
(86) PCT No.: PCT/US2022/052287

§ 371 Date: Jun. 7, 2024

Related U.S. Application Data
(60) Provisional application No. 63/341,570, filed on May 13, 2022.

(30) Foreign Application Priority Data
Dec. 10, 2021 (EP) 21213884.6

(51) Int. Cl. A01N 47/22; A01N 25/04; A01N 25/32; A01N 41/10; A01P 13/02

(52) U.S. Cl. CPC A01N 47/22; A01N 25/04; A01N 25/32; A01N 41/10; A01P 13/02

(57) ABSTRACT

The present invention primarily relates to the (selective) use of phenmedipham in the crop plants corn, cotton and soybean, and to certain herbicidally active combinations or compositions comprising (A) phenmedipham and (B) one or more aroylcyclohexanedione herbicides. The invention further relates to the use of these combinations for controlling weeds, and to corresponding methods.

This application claims the benefit of and priority to European Patent Application No. 21213884.6, filed Dec. 10, 2021, and U.S. Provisional Application Ser. No. 63/341,570, filed May 13, 2022, the entire disclosures of which are hereby incorporated by reference.

The present invention primarily relates to the (selective) use of phenmedipham in the crop plants corn, cotton, and soybean, and to certain herbicidally active combinations or compositions comprising (A) phenmedipham and (B) one or more aroylcyclohexanedione herbicides. The invention further relates to the use of these combinations for controlling weeds, and to corresponding methods.

The protection of crop plants (crops) from weed plants (weeds) and other unwanted vegetation which inhibit crop growth is a constantly recurring problem in agriculture. To help combat this problem, researchers in the field of synthetic chemistry have produced an extensive variety of active herbicidal ingredients (herbicides) and formulations effective in the control of such unwanted growth. Herbicides of many structural types and with different Modes of Action have been disclosed in the literature and a large number are in commercial use.

Active herbicidal ingredients (herbicides) are typically categorized according to their Mode of Action (MoA) (or Site of Action (SoA)). The Mode of Action of herbicides is inter alia relevant concerning the weed spectrum that herbicides are able to control and in particular with respect to the ability to control unwanted plants (weeds) which are resistant (tolerant) or are evolving resistance (tolerance) to one or more Modes of Action.

In normal use, the different classes of herbicides have proved to be very effective across a range of weeds. However, an increasing problem encountered in agriculture is the appearance of weeds that have developed a tolerance to classes of herbicides with certain Modes of Action. By ‘tolerance’ or ‘resistance’ is meant that these weeds are less easily damaged or killed by the application of these herbicides than the normal phenotype. Typically, these weeds show little or no damage when these herbicides are applied at normal application rates. This tolerance arises naturally and occurs because of the selection pressure exerted on the weed population by repeated application of these herbicides. Some weeds have developed almost complete tolerance to herbicides of a certain Mode of Action, that is, they are virtually undamaged by these herbicides at the normal commercial application rates. Sometimes the word ‘resistant’ is also used to describe such weeds, in particular where they have the inherited ability to survive treatment by these herbicides.

Herbicidal combinations often extend the weed spectrum for control relative to each of the individual active ingredients, but without producing further possibilities for use, such as deployment in other crops of useful plants, or shifting of the application window. Also, herbicidal combinations known from the prior art do not (sufficiently) solve the problem of evolving or increasing resistance developed by weed plants (weeds) to active herbicidal ingredients from certain Modes of Action, for example 4-hydroxyphenylpyruvate dioxygenase (HPPD) inhibitors such as mesotrione.

In their application, herbicidal crop protection agents (herbicides) known to date for controlling harmful plants or unwanted vegetation in some crop plants have some disadvantages, be it (a) that they have no or else insufficient herbicidal activity against specific harmful plants, (b) that the spectrum of harmful plants which can be controlled with the herbicides is not broad enough, and/or (c) that the selectivity of herbicides in and the compatibility with the crop plants is too low, thereby causing unwanted damage and/or unwanted reduced harvest yields of the said crop plants.

The active ingredient phenmedipham (IUPAC name: 3-[(methoxyformyl)amino]phenyl (3-methylphenyl)carbamate, CAS number 13684-63-4) is an active herbicidal ingredient (herbicide) known from U.S. Pat. No. 3,692,820 and is often abbreviated as PMP. Phenmedipham mainly controls unwanted broad-leaved weed plants post-emergence in certain crops, in particular in sugar beet and fodder beet. Phenmedipham is an inhibitor of the photosystem II (PSII).

US 2004/0214722 and U.S. Pat. No. 6,627,595 disclose certain surfactant/solvent systems and corresponding formulations which can comprise phenmedipham. The formulations comprising phenmedipham described in U.S. Pat. No. 9,750,251 are particularly useful for application in sugar beet.

Aroylcyclohexanedione herbicides are inhibitors of 4-hydroxyphenylpyruvate dioxygenase (HPPD). Well-known HPPD-inhibitors of the aroylcyclohexanedione-type are benquitrione, dioxopyritrione, fenquinotrione, ketospiradox, lancotrione, mesotrione, quintrione, sulcotrione, tefuryltrione, and tembotrione.

The active ingredient mesotrione (IUPAC name: 2-[4-(methylsulfonyl)-2-nitrobenzoyl]cyclohexane-1,3-dione, CAS number 104206-82-8) is an active herbicidal ingredient (herbicide) known from U.S. Pat. Nos. 5,006,158 and 5,912,207 and is often abbreviated as MST. Mesotrione can selectively control unwanted weed plants in certain crops, typically in corn (U.S. Pat. No. 5,506,195). Mesotrione is an inhibitor of the 4-hydroxyphenylpyruvate dioxygenase (HPPD).

The active ingredient sulcotrione (IUPAC name: 2-[2-chloro-4-(methylsulfonyl)benzoyl]cyclohexane-1,3-dione, CAS number 99105-77-8) is an active herbicidal ingredient (herbicide) known from EP 0 137 963 and is often abbreviated as SCT. Sulcotrione is broad-spectrum inhibitor of the 4-hydroxyphenylpyruvate dioxygenase (HPPD) and typically used to control weeds in monocotyledonous crop plants such as corn/maize.

The active ingredient tembotrione (IUPAC name: 2-{2-chloro-4-(methylsulfonyl)-3-[(2,2,2-trifluoroethoxy)methyl]benzoyl}cyclohexane-1,3-dione, CAS number 335104-84-2) is an active herbicidal ingredient (herbicide) known from U.S. Pat. No. 6,376,429 and is often abbreviated as TBT. Tembotrione is typically used to control grasses and broadleaf weeds in corn/maize. Tembotrione is an inhibitor of the 4-hydroxyphenylpyruvate dioxygenase (HPPD).

WO 01/43550 relates to a method for controlling the growth of weeds comprising the application of a mixture of a benzoyl cyclohexanedione herbicide, in particular mesotrione, and a chloroacetamide herbicide, particularly for use in corn.

A variety of publications disclose certain combinations involving the above-mentioned active HPPD inhibitors. For example, WO 95/28839, WO 02/21920 and WO 02/100173 describe herbicidal combinations comprising mesotrione and herbicidally active triazines.

WO 03/005820 teaches a process of controlling triazine-tolerant weeds by the application of a combination of mesotrione and a triazine to the locus of said weeds.

WO 2014/072250A1 relates to methods of controlling harmful plants in tolerant soybean crops using a combination of (i) at least one HPPD inhibitor and (ii) metribuzin or atrazine.

Weed Technology 2017, Vol 31, 523-535 reports on chlorophyll fluorescence imaging to detect plant injury by several herbicides in sugar beet and in soybean.

Overall, the herbicidal activity properties (above aspects (a) and (b)) and/or the selectivity/compatibility (above aspect (c)) of the herbicides used so far in useful crop plants such as corn, cotton and soybean still allow improvement.

For the reasons mentioned above, there still is a need for alternative, highly herbicidally active compositions for the selective application for controlling harmful plants or unwanted vegetation in useful crop plants such as corn, cotton, and soybean.

It has been found that phenmedipham can be used as a selective herbicide in corn, cotton, and soybean, i.e., phenmedipham does not cause agronomically inacceptable damage to corn, cotton, and soybean plants.

Generally, the maximum damage (injury) of the crop plant corn, cotton and soybean should not exceed 15%, typically should not exceed 10%, when assessed 35 days after application of the herbicide or the herbicide combination. Such a level of damage is considered as agronomically acceptable damage to corn, cotton, and soybean plants.

Surprisingly, it has now further been found that certain combinations of herbicidal active ingredients comprising phenmedipham or compositions comprising said combinations exhibit the desired herbicidal activity and are able to selectively control harmful plants or unwanted vegetation in the useful crop plants corn, cotton and soybean.

The above objects have been achieved with herbicidal combinations or compositions, wherein the active herbicidal ingredients in said combination or composition comprise or consist of
(A) phenmedipham, and
(B) one or more aroylcyclohexanedione herbicides,
   wherein the ratio by weight of the total amount of component (A) to the total amount of component (B) typically is in the range of from about 25:1 to about 1:20, and more typically is in the range of from about 20:1 to about 1:15.

Certain combinations of component (A) (phenmedipham) and one or more aroylcyclohexanedione herbicides (component (B)) have been found to exhibit a synergistic effect in killing weeds and can also be used to control weeds which are difficult to control (e.g. due to their resistance against certain types of herbicides).

Certain preferred herbicidal combinations or compositions of the present invention are those containing (A) phenmedipham and (B) one or more aroylcyclohexanedione herbicides as the sole active herbicidal ingredients.

Thus, in certain embodiments, the herbicidal combination or compositions according to the present invention contain as sole active herbicidal ingredients
(A) phenmedipham, and
(B) one or more aroylcyclohexanedione herbicides.
   wherein the ratio by weight of the total amount of component (A) to the total amount of component (B) typically are in the broad or narrower ratio ranges indicated in the context of the present invention.

The weight ratios of components (A) and (B) present in the herbicidal combination or compositions according to the present invention can be varied within certain ranges. However, within certain concentration ranges or ratio by weight ranges, the (potentially synergistic) effects observed for the combinations or compositions of the invention comprising components (A) and (B) are particularly pronounced and/or the herbicidal activity and efficacy particularly high.

Typically, in the herbicidal combinations or compositions according to the present invention the ratio by weight of the total amount of component (A) to the total amount of component (B) is in the range of from about 15:1 to about 1:15.

Typically, in the herbicidal combinations or compositions according to the present invention the ratio by weight of the total amount of component (A) to the total amount of component (B) is in the range of from about 12:1 to about 1:12.

Also typically, in the herbicidal combinations or compositions according to the present invention the ratio by weight of the total amount of component (A) to the total amount of component (B) is in the range of from about 15:1 to about 1:5, preferably in the range of from about 15:1 to about 1:2.

More typically, in the herbicidal combinations or compositions according to the present invention the ratio by weight of the total amount of component (A) to the total amount of component (B) is in the range of from about 15:1 to about 1:5, preferably in the range of from about 12:1 to about 1:1.

Still more typically, in the herbicidal combinations or compositions according to the present invention the ratio by weight of the total amount of component (A) to the total amount of component (B) is greater than 1:1.

In certain embodiments the ratio by weight of the total amount of component (A) to the total amount of component (B) is in the range of from about 12:1 to about 5:4.

In some embodiments, in the herbicidal combinations or compositions according to the present invention the ratio by weight of the total amount of component (A) to the total amount of component (B) is in the range of from about 10:1 to about 3:2.

All ratios of component (A) and component (B) mentioned in the context of the herbicidal combinations or compositions according to the present invention are in each case based on the total weight of the herbicidal combination or composition.

In various herbicidal combinations or compositions according to the present invention, component (B) comprises or consists of one or more aroylcyclohexanedione herbicides selected from the group consisting of benquitrione, dioxopyritrione, fenquinotrione, ketospiradox, lancotrione, mesotrione, quintrione, sulcotrione, tefuryltrione, or tembotrione, and mixtures thereof.

In certain herbicidal combinations or compositions according to the present invention, component (B) comprises or consists of one or more aroylcyclohexanedione herbicides selected from the group consisting of mesotrione, sulcotrione, or tembotrione, and mixtures thereof.

In other herbicidal combinations or compositions according to the present invention, component (B) comprises or consists of mesotrione. For example, in certain embodiments of the present invention component (B) comprises or consists of mesotrione.

In certain herbicidal combinations or compositions according to the present invention the ratio by weight of the total amount of component (A) phenmedipham to the total amount of mesotrione as (part of) component (B) is in the range of from about 15:1 to about 1:10, and typically is in the range of from about 15:1 to about 1:5, more typically is in the range of from about 12:1 to about 1:1.

In certain herbicidal combinations or compositions according to the present invention the ratio by weight of the total amount of component (A) phenmedipham to the total amount of mesotrione as (part of) component (B) is greater than 1:1.

In certain herbicidal combinations or compositions according to the present invention the ratio by weight of the total amount of component (A) phenmedipham to the total amount of mesotrione as (part of) component (B) is in the range of from about 12:1 to about 5:4, typically is in the range of from about 10:1 to about 3:2.

The herbicidal combinations or compositions according to the present invention typically additionally comprise one or more further constituents selected from the group consisting of further herbicides, water, formulation adjuvants (preferably comprising one or more alkyl esters, in particular rapeseed oil methyl ester, rapeseed oil ethyl ester, soybean oil methyl ester or soybean oil ethyl ester, see below), and safeners.

The herbicidal combination or composition according to the present invention preferably is a composition (i.e. a mixture), preferably in the form of a concentrated formulation or a ready-to-use spray application mixture.

The herbicidal combinations or compositions of the invention may comprise or else be used together with additional, further components, examples being active crop protection ingredients of other kinds and/or adjuvants customary in crop protection and/or formulation assistants.

Thus, the herbicidal combinations or compositions according to the present invention typically additionally comprise one or more further constituents selected from the group consisting of water, formulation adjuvants and safeners.

Depending inter alia on the requirements of the crop plants or the weed plants present in the area where the crop plants grow or are intended to grow, it may be desired or necessary to further complement and optimize the weed control spectrum of the combinations or compositions of the present invention, the combinations and compositions according to the present invention may be combined with one or more further herbicides.

Thus, the herbicidal combinations or compositions according to the present invention in some embodiments typically additionally comprise one or more further herbicides.

Safeners and further herbicides optionally incorporated into the herbicidal combinations and compositions of the present invention and the common names used herein are known in the art; see, for example, “The Pesticide Manual” 16^{th} Edition, British Crop Protection Council 2012; these include the known stereoisomers (in particular racemic and enantiomeric pure isomers) and derivatives such as salts or esters, and particularly the commercially customary forms. Where a herbicide is referenced generically herein by name, unless otherwise restricted, that herbicide includes all commercially available forms known in the art such as salts, esters, free acids and free bases, as well as stereoisomers thereof. For example, where the herbicide name “glyphosate” is used, glyphosate acid, salts and esters are within the scope thereof.

In these and other embodiments, the one or more further herbicides can be selected from the group consisting of acetyl CoA carboxylase (ACCase) inhibitors, enolpyruvyl shikimate-3-phosphate synthase (EPSPS) inhibitors, glutamine synthetase inhibitors, auxins, photosystem I (PS I) inhibitors, photosystem II (PS II) inhibitors, acetolactate synthase (ALS) or acetohydroxy acid synthase (AHAS) inhibitors, 4-hydroxyphenylpyruvate dioxygenase (HPPD) inhibitors, protoporphyrinogen oxidase (PPO) inhibitors, cellulose inhibitors, mitosis inhibitors, oxidative phosphorylation uncouplers, dihydropteroate synthase inhibitors, fatty acid and lipid biosynthesis inhibitors, auxin transport inhibitors and carotenoid biosynthesis inhibitors, salts and esters thereof, racemic mixtures and resolved isomers thereof, and mixtures thereof.

The Weed Science Society of America (WSSA) publishes the “Herbicide Site of Action (SoA) Classification List” in which the various herbicides are grouped according to their Site of Action. These WSSA Groups are known to those skilled in the art.

In the context of the present invention, to further complement and optimize the weed control spectrum of the combinations or compositions of the present invention, in certain embodiments, the additional one or more herbicides with which the herbicidal combinations or compositions according to the present invention may be combined or mixed are selected from the group consisting of herbicides from WSSA Group 4 (auxin herbicides), WSSA Group 14 (protoporphyrinogen oxidase (PPO) inhibitor herbicides), glyphosate and glufosinate.

Herbicides from WSSA Group 4 are auxin herbicides which include benzoic acid herbicides, phenoxy herbicides, pyridine carboxylic acid herbicides, pyridineoxy herbicides, pyrimidine carboxy herbicides, quinoline carboxylic acid herbicides, and benzothiazole herbicides. Specific examples of auxin herbicides suitable to be combined with combinations and compositions according to the present invention include dicamba (3,6-dichloro-2-methoxy benzoic acid); 2,4-D (2,4-dichlorophenoxyacetic acid); 2,4-DB (4-(2,4-dichlorophenoxy)butanoic acid); dichloroprop (2-(2,4-dichlorophenoxy)propanoic acid); MCPA ((4-chloro-2-methylphenoxy)acetic acid); MCPB (4-(4-chloro-2-methylphenoxy)butanoic acid); aminopyralid (4-amino-3,6-dichloro-2-pyridinecarboxylic acid); fluoroxpyr ([(4-amino-3,5-dichloro-6-fluoro-2-pyridinyl)oxy]acetic acid); triclopyr ([(3,5,6-trichloro-2-pyridinyl)oxy]acetic acid); diclopyr; mecoprop ((2-(4-chloro-2-methylphenoxy)propanoic acid); mecoprop-P; picloram (4-amino-3,5,6-trichloro-2-pyridinecarboxylic acid); quinclorac (3,7-dichloro-8-quinolinecarboxylic acid); quinmerac (7-chloro-3-methyl-8-quinolinecarboxylic acid); aminocyclopyrachlor (6-amino-5-chloro-2-cyclopropyl-4-pyrimidinecarboxylic acid); benazolin; halauxifen; fluorpyrauxifen; methyl 4-amino-3-chloro-5-fluoro-6-(7-fluoro-1H-indol-6-yl)pyridine-2-carboxylate; 4-amino-3-chloro-5-fluoro-6-(7-fluoro-1H-indol-6-yl)pyridine-2-carboxylic acid; benzyl 4-amino-3-chloro-5-fluoro-6-(7-fluoro-1H-indol-6-yl)pyridine-2-carboxylate; methyl 4-amino-3-chloro-5-fluoro-6-(7-fluoro-1-isobutyryl-1H-indol-6-yl)pyridine-2-carboxylate; methyl 4-amino-3-chloro-6-[1-(2,2-dimethylpropanoyl)-7-fluoro-1H-indol-6-yl]-5-fluoropyridine-2-carboxylate; methyl 4-amino-3-chloro-5-fluoro-6-[7-fluoro-1-(methoxyacetyl)-1H-indol-6-yl]pyridine-2-carboxylate; methyl 6-(1-acetyl-7-fluoro-1H-indol-6-yl)-4-amino-3-chloro-5-fluoropyridine-2-carboxylate; potassium 4-amino-3-chloro-5-fluoro-6-(7-fluoro-1H-indol-6-yl)pyridine-2-carboxylate; and butyl 4-amino-3-chloro-5-fluoro-6-(7-fluoro-1H-indol-6-yl)pyridine-2-carboxylate; including agriculturally acceptable salts and esters thereof, racemic mixtures and resolved isomers thereof; and combinations thereof.

In various embodiments, the auxin herbicide comprises dicamba and/or a salt thereof. Examples of dicamba salts include the monoethanolamine, tetrabutylamine, dimethylamine (e.g., BANVEL, ORACLE, etc.), isopropylamine, diglycolamine (e.g., CLARITY, VANQUISH, etc.), potassium, and sodium salts, and combinations thereof. Commercially available sources of dicamba and its salts includes those products sold under the trade names BANVEL, CLARITY, DIABLO, DISTINCT, ORACLE, VANQUISH, and VISION.

In various embodiments, the auxin herbicide component comprises 2,4-D and/or a salt thereof. Examples of 2,4-D salts include the choline, dimethylamine, and isopropylamine salts, and combinations thereof. Commercially available sources of 2,4-D and its salts include those products sold under trade names BARRAGE, FORMULA 40, OPT-AMINE, and WEEDAR 64.

Herbicide off-site movement (migration) is often associated with certain herbicides. Herbicide off-site movement can occur primarily by physical movement or drift of small particles in the spray, contamination of the sprayer, and volatility of the herbicide after application. Volatile herbicides can, under certain application conditions, vaporize into the surrounding atmosphere and migrate from the application site to adjacent crop plants, such as soybeans, corn, or cotton, where contact damage to sensitive plants can occur. Spray drift can be attributed to both volatility and the physical movement of small particles from the target site to adjacent crop plants.

Volatility control agents and drift reduction agents are known in the art.

To address drift issues, drift reduction agents (DRAs) (also known as drift retardant agents or drift control agents) can be included in herbicidal compositions. DRAs for herbicidal sprays can work by modifying the size distribution of particles formed by the nozzle. The first type of DRA are polymers, which can increase the extensional viscosity of the spray mixture. These polymers, so far largely limited in commercial practice to polyacrylamides, polyethylene oxide, and guar gum, can shift the spray particle size distribution to larger diameters and be effective in reducing driftable fines for some nozzles. The second type of DRA is known as “oil-type” or “emulsion-type” DRA. As the name suggests, an oil-type DRA, largely immiscible with water, can be included in a tank mix as an emulsion or microemulsion. DRAs of this type are available commercially as additives to a spray tank. These oil-type or emulsion-type DRAs can be effective at the suppression of driftable fines and work well in a wide variety of nozzles.

For example, Monsanto (Bayer) has addressed volatility by adding potassium acetate, with the trade name Vaporgrip™ technology, to auxin herbicide formulations.

Thus, the herbicidal combinations or compositions according to the present invention typically additionally comprise one or more further constituents selected from the group consisting of offsite movement controlling agents, more typically selected from the group consisting of volatility control agents and drift reduction agents (DRAs).

In the context of the herbicidal combinations or compositions according to the present invention the volatility control agents typically comprise or consist of one or more C1-C10 monocarboxylic acids, or a monocarboxylate salt thereof, for example those described in WO 2014/071374. More typically the volatility control agents used in the context of the herbicidal combinations or compositions according to the present invention comprise or consist of formic acid, acetic acid, propionic acid, benzoic acid and alkali metal salts thereof, even more preferably comprise or consist of potassium formate, sodium formate, potassium acetate and/or sodium acetate.

In the context of the herbicidal combinations or compositions according to the present invention typically
the polymeric drift reducing agents have a molecular weight of 50,000 Dalton or more, and more typically are selected from the group of polyacrylamides, polyethylene oxides, or guar gums having a molecular weight of 50,000 Dalton or more, and mixtures thereof,
and/or
the drift reducing agents of the “oil-type” or “emulsion-type” are oily substances selected from the group consisting of fatty triglycerides, fatty hydrocarbons, fatty alcohols, fatty esters, vegetable oils, and mixtures thereof. In context of the oily substances, the term “fatty”, refers to a hydrocarbon chain with C8-C30 carbon atoms, preferably to a hydrocarbon chain with C12-C22 carbon atoms.

In some embodiments it may be beneficial that the herbicidal combinations or compositions according to the present invention additionally comprise at least one volatility control agent and at least one drift reduction agent.

In the context of the present invention, in certain embodiments, the additional herbicide with which the herbicidal combinations or compositions according to the present invention may be combined or mixed is glyphosate and/or salts thereof. Examples of suitable salts of glyphosate are the mono-salts and di-salts of glyphosate and monoethanolamine, diethanolamine, triethanolamine, dimethylamine, n-propylamine, isopropylamine, trimesium, potassium or sodium, and combinations thereof.

In the context of the present invention, in certain embodiments, the additional herbicide with which the herbicidal combinations or compositions according to the present invention may be combined or mixed is glufosinate and/or salts thereof. Examples of suitable salts of glufosinate are the mono-ammonium salts and mono-sodium salts of glufosinate, and combinations thereof.

In certain embodiments, the herbicidal combinations or compositions of the invention surprisingly show not only a synergistic effect towards unwanted weed plants but also, furthermore, other desired qualities: for instance, they can be applied within a broad time window in crops of useful plants against unwanted weed plants, without significant damage to the useful plants. A further surprising effect is the fact that herbicidal combinations or compositions of the invention may display a synergistic effect towards weed plants, also to some weed plants which have developed resistance to one or more Modes of Action, such as to HPPD inhibitors.

The herbicidal combinations of the invention can be applied in a manner known to the skilled person, as for example together (for example as a co-formulation or as a tank mix) or else a short time after one another (splitting), for example to the plants, plant parts or plant seeds or to the area on which the plants are growing. Possible, for example, is the application of the individual active ingredients or of the herbicidal combinations in two or more portions (sequential application), for example after pre-emergence applications, followed by post-emergence applications, or after early post-emergence applications, followed by applications in the middle or late post-emergence phase. Preference here is given to joint or near-synchronous application of components (A) and (B).

If a herbicidal composition is applied to the soil surface before or after germination of the plant but prior to emergence from the soil, the treatment is called a pre-emergence treatment.

If a herbicidal composition is applied to the soil surface after emergence of the plant, the treatment is called a post-emergence treatment.

Preferred in the context of certain embodiments of the present invention is the use of the combinations or compositions defined in the context of the present invention in post-emergence treatment in crop plants, in particular in crop plants selected from the group consisting of corn, cotton or soybean.

In a further aspect, the present invention relates to methods for controlling weed plants in crops of useful plants, characterized in that a herbicidal combination or composition according to the present invention is applied to the weed plants, plants, plant seeds, or to the area on which the weed plants are growing.

In the context of the present invention “controlling” in connection with unwanted plant growth, weed plants, harmful plants or unwanted plants denotes a significant reduction of the growth of the harmful plant(s) in comparison to the untreated harmful plants. Typically, the growth of the harmful plant(s) is essentially diminished (60-79%), more typically the growth of the harmful plant(s) is largely or fully suppressed (80-100%), and in particular the growth of the harmful plant(s) is almost fully or fully suppressed (90-100%).

In a further aspect, the present invention relates the use of a herbicidal combination or composition according to the present invention for controlling unwanted plants in crops of useful plants.

When the herbicidal combinations or compositions of the invention are used, a very broad spectrum of weed plants are controlled pre-emergence and post-emergence, examples being annual and perennial monocotyledonous weeds, dicotyledonous weeds, and also unwanted crop plants.

The method or use according to the present invention can be carried out pre-emergence, early post-emergence or post-emergence of the weed plants, preferably post-emergence or post-emergence of the weed plants.

The method or use according to the present invention can be carried out pre-emergence, early post-emergence or post-emergence of the crop plants, preferably post-emergence or post-emergence of the crop plants.

In view of the level of control of weeds achieved, i.e., the herbicidal activity, in certain embodiments, the herbicidal combinations or compositions according to the present invention are applied early post-emergence or post-emergence of the weed plants and early post-emergence or post-emergence of the crop plants.

Thus, in various embodiments, the method or use according to the present invention is carried early post-emergence or post-emergence of the weed plants and early post-emergence or post-emergence of the crop plants.

The herbicidal combinations or compositions of the invention are particularly suitable for use in crops such as cereals, maize (corn), rice, soybean, oilseed rape, sugarbeet, cotton and sugarcane, and for use in long-term crops, in plantations and on non-crop land. Preference may be given to their use in crops of corn, cotton and soybean. They are also very suitable for use in transgenic useful crops, such as corn, cotton and soybean.

Thus, certain methods or uses according to the present invention are characterized in that the crop plants are selected from the group consisting of corn, cotton and soybean.

The method or use according to the present invention in certain embodiments are characterized in that the crop plants have been genetically modified.

The present invention accordingly further provides methods for controlling unwanted plants in plant crops that is characterized in that components (A) and (B) of the herbicidal combinations or compositions of the invention are applied to the plants (e.g. weed plants such as monocotyledonous or dicotyledonous weeds or unwanted crop plants) or to the area on which the plants are growing, such application taking place jointly or separately, for example.

By unwanted plants are meant all plants that are growing at locations where they are unwanted. These may be, for example, weed plants (e.g., monocotyledonous or dicotyledonous weeds or unwanted crop plants).

Monocotyledonous weeds belong, for example, to the genera Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Jschaemum, Sphenoclea, Dactyloctenium, Agrostis, Alopecurus and Apera.

Dicotyledonous weeds belong, for example, to the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Kochia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum and Euphorbia.

The present invention also provides for the use of the herbicidal combinations or compositions of the present invention for controlling unwanted plant growth, preferably in crops of useful plants.

In certain embodiments, the herbicidal combinations or compositions of the present invention particularly show unexpected herbicidal activity against dicotyledonous weeds, in particular when applied (early) post-emergence.

The present invention also relates to methods or uses of the herbicidal combinations or compositions of the present invention, characterized in that it is carried out for difficult to control weeds or plants.

Relevant examples of such difficult to control weeds in the context of the present invention include the following dicotyledonous weeds: Amaranthus retroflexus, Amaranthus viridis, Bidens pilosa, Euphorbia heterophylla, Ipomoea aristolochiaefolia, Kochia scoparia or Stellaria media.

In certain embodiments, synergistic herbicidal effects were also observed against monocotyledonous weeds such as Brachiaria decumbens, Bromus tectorum, Cenchrus echinatus, Echinochloa crus-galli, Eleusine indica, or Panicum ramosum. The level of control or herbicidal activity however was observed to be generally somewhat lower than in case of dicotyledonous weeds.

In one aspect, the method or use is carried out for controlling weeds or plants having a resistance to herbicides of one or more different Modes of Action, wherein the resistance preferably is selected from the group consisting of auxin herbicide resistance, glyphosate resistance, acetolactate synthase (ALS) inhibitor resistance, 4-hydroxyphenylpyruvate dioxygenase (HPPD) inhibitor resistance, CoA carboxylase (ACCase) inhibitor resistance, photosystem I (PS I) inhibitor resistance, photosystem II (PS II) inhibitor resistance, and protoporphyrinogen oxidase (PPO) inhibitor resistance.

In the context of the present invention, the application rate of component (A) (phenmedipham) typically is at least about 12.5 g/ha (active ingredient in gram per hectare),
and/or
the application rate of component (B) (e.g., mesotrione) typically is at least about 12.5 g/ha (active ingredient in gram per hectare).

In the context of the present invention, the application rate of component (A) (phenmedipham) typically is from about 12.5 g/ha to about 400 g/ha (active ingredient in gram per hectare), more typically from about 25 g/ha to about 300 g/ha, even more typically from about 25 g/ha to about 250 g/ha. In at least one embodiment, the application rate of component (A) (phenmedipham) is in the range of from about 50 g/ha to about 200 g/ha.

In the context of the present invention, the application rate of component (B) (e.g., mesotrione) typically is from about 12.5 g/ha to about 300 g/ha (active ingredient in gram per hectare), more typically from about 12.5 g/ha to about 250 g/ha, even more typically of from about 25 g/ha to about 200 g/ha. In at least one embodiment, the application rate of component (B) (e.g., mesotrione) is in the range of from about 25 g/ha to about 150 g/ha.

The present invention typically also relates to a method or the use of the herbicidal combinations or compositions of the invention, characterized in that component (A) (phenmedipham) is used at an application rate of from about 12.5 g/ha to about 400 g/ha and component (B) (e.g., mesotrione) at an application rate of from about 12.5 g/ha to about 300 g/ha.

The present invention typically also relates to a method or the use of the herbicidal combinations of the invention, characterized in that component (A) (phenmedipham) is used at an application rate of from about 25 g/ha to about 300 g/ha and component (B) (e.g., mesotrione) at an application rate of from about 12.5 g/ha to about 250 g/ha.

The present invention also relates to methods or uses of the herbicidal combinations or compositions of the invention, characterized in that component (A) (phenmedipham) is used at an application rate of from about 25 g/ha to about 250 g/ha and component (B) (e.g., mesotrione) at an application rate of from about 25 g/ha to about 200 g/ha.

The present invention typically also relates to methods or uses of the herbicidal combinations or compositions of the invention, characterized in that component (A) (phenmedipham) is used at an application rate of from about 50 g/ha to about 200 g/ha and component (B) (e.g., mesotrione) at an application rate of from about 25 g/ha to about 150 g/ha.

In some aspects, the present invention also relates to methods or uses of the herbicidal combinations or compositions of the invention, characterized in that component (A) (phenmedipham) is used at an application rate of from about 100 g/ha to about 250 g/ha and component (B) (e.g., mesotrione) at an application rate of less than about 130 g/ha.

Typically, component (B) (e.g., mesotrione) is applied or used at an application rate not exceeding about 130 g/ha, more typically not exceeding about 105 g/ha.

The herbicidal combinations or compositions of the invention comprising components (A) and (B) can be produced by known methods, for example as mixed formulations of the individual components, optionally with further active ingredients, adjuvants and/or customary formulation assistants, these combinations being then employed in a customary way as dilutions with water, or may be produced in the form of what are called tank mixes, by joint dilution of the separately formulated or partially separately formulated individual components with water. Likewise possible is the temporally offset application (split application) of the separately formulated or partially separately formulated individual components. Another possibility is the application of the individual components or of the herbicidal combinations in two or more portions (sequential application), as for example after applications pre-emergence, followed by post-emergence applications, or after early post-emergence applications, followed by applications in the middle or late post-emergence phase. Preference may be given to the joint or near-synchronous application of the active ingredients of the respective combination, wherein the active ingredients comprise or consist of components (A) and (B).

Certain embodiments of the present invention are characterized in that the components (A) and (B) of the combinations of the present invention are applied sequentially.

Other embodiments of the present invention are characterized in that the components (A) and (B) are applied together, i.e. as a mixture. Thus, in certain embodiments, components (A) and (B) are part of a composition, and certain methods or uses according to the present invention are characterized in that the components (A) and (B) are applied as a composition.

The herbicidal combinations or compositions of the invention can also be used for controlling weed plants in crops of genetically modified plants that are either already known or are yet to be developed.

In general, transgenic plants are notable for special advantageous properties, for example for resistances to certain pesticides, in particular certain herbicides, resistances to plant diseases or organisms that cause plant diseases, such as certain insects or microorganisms such as fungi, bacteria or viruses. Other special properties relate, for example, to the harvested material with regard to quantity, quality, storability, combination and specific constituents. For instance, there are known transgenic plants with an elevated starch content or altered starch quality, or with a different fatty acid combination in the harvested material. Other special properties may be tolerance or resistance to abiotic stressors, for example heat, low temperatures, drought, salinity and ultraviolet radiation.

Conventional ways of producing new plants which have modified properties in comparison to plants which have existed to date involve, for example, traditional breeding methods and the generation of mutants. Alternatively, new plants with modified properties can be generated with the aid of recombinant methods (see, for example, EP-A-0221044, EP-A-0131624). For example, there have been multiple descriptions of:
genetic modifications of crop plants for the purpose of modifying the starch synthesized in the plants (for example WO 92/11376, WO 92/14827, WO 91/19806)
transgenic crop plants which are resistant to particular herbicides of the glufosinate type (cf., for example, EP-A-0242236, EP-A-242246) or glyphosate type (WO 92/00377) or of the sulphonylurea type (EP-A-0257993, U.S. Pat. No. 5,013,659)
transgenic crop plants, for example cotton, with the ability to produce Bacillus thuringiensis toxins (Bt toxins), which make the plants resistant to particular pests (EP-A-0142924, EP-A-0193259)
transgenic crop plants with a modified fatty acid combination (WO 91/13972)
genetically modified crop plants with new plant constituents or secondary metabolites, for example new phytoalexins, which bring about an increased disease resistance (EPA 309862, EPA0464461)
genetically modified plants with reduced photorespiration, which feature higher yields and higher stress tolerance (EPA 0305398)
transgenic crop plants which produce pharmaceutically or diagnostically important proteins (“molecular pharming”)
transgenic crop plants which feature higher yields or better quality
transgenic crop plants which feature a combination, for example, of the abovementioned new properties (“gene stacking”)

A large number of molecular-biological techniques by means of which new transgenic plants with modified properties can be produced are known in principle; see, for example, I. Potrykus and G. Spangenberg (eds.), Gene Transfer to Plants, Springer Lab Manual (1995), Springer Verlag Berlin, Heidelberg, or Christou, “Trends in Plant Science” 1 (1996) 423-431).

For such recombinant manipulations, nucleic acid molecules which allow mutagenesis or a sequence change by recombination of DNA sequences can be introduced into plasmids. With the aid of standard methods, it is possible, for example, to undertake base exchanges, remove parts of sequences or add natural or synthetic sequences. For the joining of the DNA fragments to one another, adaptors or linkers can be attached to the fragments; see, for example, Sambrook et al., 1989, Molecular Cloning, A Laboratory Manual, 2nd ed. Cold Spring Harbor Laboratory Press, Cold Spring Harbor, NY; or Winnacker “Gene und Klone” [Genes and Clones], VCH Weinheim 2nd edition 1996.

For example, the production of plant cells with a reduced activity of a gene product can be achieved by expressing at least one corresponding antisense RNA, a sense RNA for achieving a cosuppression effect, or by expressing at least one suitably constructed ribozyme which specifically cleaves transcripts of the abovementioned gene product.

To this end, it is possible firstly to use DNA molecules which encompass the entire coding sequence of a gene product inclusive of any flanking sequences which may be present, and also DNA molecules which only encompass portions of the coding sequence, it being necessary for these portions to be long enough to have an antisense effect in the cells. The use of DNA sequences which have a high degree of homology to the coding sequences of a gene product, but are not completely identical to them, is also possible.

When expressing nucleic acid molecules in plants, the protein synthesized may be localized in any desired compartment of the plant cell. However, in order to achieve localization in a particular compartment, it is possible, for example, to join the coding region to DNA sequences which ensure localization in a particular compartment. Such sequences are known to the skilled person (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106). The nucleic acid molecules can also be expressed in the organelles of the plant cells.

The transgenic plant cells can be regenerated by known techniques to give whole plants. In principle, the transgenic plants may be plants of any desired plant species, i.e., both monocotyledonous and dicotyledonous plants.

For instance, it is possible to obtain transgenic plants whose properties are altered by overexpression, suppression, or inhibition of homologous (i.e., natural) genes or gene sequences, or expression of heterologous (i.e., foreign) genes or gene sequences.

Preferably the combinations or compositions according to the invention can be used in transgenic crop plants (crops) which are resistant to auxin herbicides such as, for example, dicamba, or to herbicides which inhibit essential plant enzymes, for example acetolactate synthases (ALS), EPSP synthases, glutamine synthases (GS) or 4-hydroxyphenylpyruvate dioxygenases (HPPD).

On employment of the combinations or compositions of the invention in transgenic crops, the effects toward weed plants observed in other crops are often also accompanied by effects which are specific to application in the particular transgenic crop, for example an altered or specifically widened spectrum of weeds which can be controlled, altered application rates which can be used for the application, preferably good combinability with the herbicides to which the transgenic crop is resistant, and influencing of growth and yield of the transgenic crop plants.

The invention therefore also provides for the use of the combinations or compositions of the invention for controlling weed plants in transgenic crop plants.

Preference may be given to the use of the combinations or compositions of the invention in economically important transgenic crops of useful plants and ornamentals, for example of cereals (e.g. wheat, barley, rye, oats), millet/sorghum, rice, cassava and maize (corn), or else crops of sugarbeet, cotton, soybean, oilseed rape, potato, tomato, peas and other vegetable crops, especially in corn, cotton and soybean.

The invention therefore also provides for the use of the combinations or compositions of the invention for controlling weed plants in transgenic crop plants or crop plants having tolerance through selective breeding.

The components (A) and (B) can be converted together or separately into customary formulations, for example for application by spraying, watering and sprinkling, such as solutions, emulsions, suspensions, powders, foams, pastes, granules, aerosols, active ingredient-impregnated natural and synthetic substances, and microencapsulations in polymeric substances. The formulations may comprise the customary auxiliaries and adjuvants.

These formulations are produced in a known manner, for example by mixing the components (A) and (B) with extenders, i.e., liquid solvents, pressurized liquefied gases and/or solid carriers, optionally with use of surfactants, i.e., emulsifiers and/or dispersants and/or foam formers.

If the extender used is water, it is also possible to use, for example, organic solvents as auxiliary solvents. Useful liquid solvents are essentially: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example petroleum fractions, mineral and vegetable oils, alcohols, such as butanol or glycol and the ethers and esters thereof, ketones, such as acetone, methyl ethyl ketone, methyl isobutyl ketone or cyclohexanone, strongly polar solvents, such as dimethylformamide or dimethyl sulphoxide, and water.

Useful solid carriers include: for example ammonium salts and ground natural minerals, such as kaolins, clays, talc, chalk, quartz, attapulgite, montmorillonite or diatomaceous earth, and ground synthetic minerals, such as finely divided silica, alumina and silicates; useful solid carriers for granules include: for example crushed and fractionated natural rocks, such as calcite, marble, pumice, sepiolite, dolomite and synthetic granules of inorganic and organic flours, and granules of organic material, such as sawdust, coconut shells, maize cobs and tobacco stalks; useful emulsifiers and/or foam formers include: for example nonionic and anionic emulsifiers, such as polyoxyethylene fatty acid esters, polyoxyethylene fatty alcohol ethers, e.g. alkylaryl polyglycol ethers, alkylsulphonates, alkyl sulphates, arylsulphonates and protein hydrolysates; useful dispersants include: for example lignosulphite waste liquors and methylcellulose.

In the formulations, it is possible to use tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids. Further additives may be mineral and vegetable oils.

It is possible to use colorants such as inorganic pigments, for example iron oxide, titanium oxide and Prussian Blue, and organic dyes, such as alizarin dyes, azo dyes and metal phthalocyanine dyes, and trace nutrients such as salts of iron, manganese, boron, copper, cobalt, molybdenum and zinc.

The products or formulations comprising the components (A) and (B) as defined in the context of the present invention generally contain between 1 and 95 percent by weight of components (A) and (B), typically between 5 and 90% by weight.

The active compound concentration of the herbicidal combinations of the present invention in wettable powders is, for example, approximately 10 to 95% by weight, the remainder to 100% by weight being composed of customary formulation constituents. In the case of emulsifiable concentrates, the concentration of the components (A) and (B) may amount to, for example, 5 to 80% by weight. Formulations in the form of dusts comprise, in most cases, 5 to 20% by weight of the components (A) and (B), sprayable solutions approximately 0.2 to 25% by weight of the components (A) and (B). In the case of granules such as dispersible granules, the active compound content depends partly on whether the active compound is present in liquid or solid form and on which granulation auxiliaries and fillers are being used. As a rule, the content of the components (A) and (B) amounts to between 10 and 90% by weight in the case of the water-dispersible granules.

In addition, the herbicidal combinations of the present invention may comprise, if appropriate, adhesives, wetters, dispersants, emulsifiers, preservatives, antifreeze agents, solvents, fillers, colorants, carriers, antifoams, evaporation inhibitors, pH regulators or viscosity regulators conventional in the field of agrochemical formulations.

The herbicidal action of the herbicidal combinations of the present invention can be improved, for example, by surfactants, preferably by wetters from the group of the fatty alcohol polyglycol ethers. The fatty alcohol polyglycol ethers typically contain 10-18 carbon atoms in the fatty alcohol radical and 2-20 ethylene oxide units in the polyglycol ether moiety. The fatty alcohol polyglycol ethers can be nonionic or ionic, for example in the form of fatty alcohol polyglycol ethers sulfates, which can be used, for example, as alkali metal salts (e.g. sodium salts or potassium salts) or ammonium salts, but also as alkaline earth metal salts such as magnesium salts, such as sodium C₁₂/C₁₄-fatty alcohol diglycol ether sulfate (Genapol® LRO, Clariant); see, for example, EP-A-0476555, EP-A-0048436, EP-A-0336151 or U.S. Pat. No. 4,400,196 and also Proc. EWRS Symp. “Factors Affecting Herbicidal Activity and Selectivity”, 227-232 (1988). Nonionic fatty alcohol polyglycol ethers are, for example, (C₁₀-C₁₈)—, typically (C₁₀-C₁₄)-fatty alkohol polyglycol ethers containing 2-20, typically 3-15, ethylene oxide units (e.g. isotridecyl alcohol polyglycol ether), for example from the Genapol® series, such as Genapol® X-030, Genapol® X-060, Genapol® X-080 or Genapol® X-150 (all from Clariant).

The present invention furthermore embraces the combination of herbicidal combinations of the present invention with the wetting agents mentioned above from the group of the fatty alcohol polyglycolethers which typically contain 10-18 carbon atoms in the fatty alcohol radical and 2-20 ethylene oxide units in the polyglycol ether moiety and which can be present in nonionic or ionic form (for example as fatty alcohol polyglycol ether sulfates). Preference is given to C₁₂/C₁₄-fatty alcohol diglycol ether sulfate sodium (Genapol® LRO, Clariant); and isotridecyl alcohol polyglycol ether with 3-15 ethylene oxide units, for example from the Genapol® X series, such as Genapol® X-030, Genapol® X-060, Genapol® X-080 or Genapol® X-150 (all from Clariant). It is furthermore known that fatty alcohol polyglycol ethers such as nonionic or ionic fatty alcohol polyglycol ethers (for example fatty alcohol polyglycol ether sulfates) are also suitable for use as penetrants and activity enhancers for a number of other herbicides, inter alia also for herbicides from the group of the imidazolinones (see, for example, EP-A-0502014).

Moreover, it is known that fatty alcohol polyglycol ethers such as nonionic or ionic fatty alcohol polyglycol ethers (for example fatty alcohol polyglycol ether sulfates) are also suitable as penetrants and synergists for a number of other herbicides, inter alia also herbicides from the group of the imidazolinones; (see, for example, EP-A-0502014).

The herbicidal effect of the herbicidal combinations or compositions according to the invention can be increased further using vegetable oils. The term vegetable oils is to be understood as meaning oils from oil-plant species, such as soya oil, rapeseed oil, corn oil, sunflower oil, cottonseed oil, linseed oil, coconut oil, palm oil, safflower oil or castor oil, in particular rapeseed oil, and their transesterification products, for example alkyl esters, such as rapeseed oil methyl ester, rapeseed oil ethyl ester, soybean oil methyl ester or soybean oil ethyl ester.

The vegetable oils are preferably esters of C₁₀-C₂₂—, preferably C₁₂-C₂₀-fatty acids. The C₁₀-C₂₂-fatty acid esters are, for example, esters of unsaturated or saturated C₁₀-C₂₂-fatty acids, in particular those with an even number of carbon atoms, for example erucic acid, lauric acid, palmitic acid and, in particular, Cis-fatty acids such as stearic acid, oleic acid, linoleic acid or linolenic acid.

Examples of C₁₀-C₂₂-fatty acid esters are esters obtained by reacting glycerol or glycol with the C₁₀-C₂₂-fatty acids as they exist, for example in oils from oil-plant species, or C₁-C₂₀-alkyl-C₁₀C₂₂-fatty acid esters as can be obtained, for example, by transesterification of the abovementioned glycerol- or glycol-C₁₀-C₂₂-fatty acid esters with C₁-C₂₀-alcohols (for example methanol, ethanol, propanol or butanol). Transesterification can be carried out by known methods as are described, for example, in Römpp Chemie Lexikon, 9th edition, volume 2, page 1343, Thieme Verlag Stuttgart.

Suitable C₁-C₂₀-alkyl-C₁₀-C₂₂-fatty acid esters are the methyl, ethyl, propyl, butyl, 2-ethylhexyl and dodecyl esters. Suitable glycol- and glycerol-C₁₀-C₂₂-fatty acid esters are the uniform or mixed glycol esters and glycerol esters of C₁₀-C₂₂-fatty acids, in particular those fatty acids which have an even number of carbon atoms, for example erucic acid, lauric acid, palmitic acid and, in particular, Cis-fatty acids such as stearic acid, oleic acid, linolic acid or linolenic acid.

In further embodiments, the present invention embraces herbicidal combinations comprising constituents (A) and (B) as defined in the context of the present invention with the vegetable oils mentioned above, such as rapeseed oil, typically in the form of commercially available oil-containing formulation additives, in particular those based on rapeseed oil, in particular having as main constituent: rapeseed oil methyl ester, such as Actirob®B (Novance, France), Rako-Binol® (Bayer AG, Germany), Renol® (Stefes, Germany), Stefes Mero® (Stefes, Germany), Adjuvante Agricola Aureo® (Agro Bayer, Brazil).

In further embodiments, the present invention embraces herbicidal combinations comprising constituents (A) and (B) as defined in the context of the present invention with the vegetable oils mentioned above, such as (alkylated) soybean oil, typically in the form of commercially available oil-containing formulation additives, in particular those based on soybean oil, in particular having as main constituent soybean oil methyl ester, such as Adjuvante Agricola Aureo® (Agro Bayer, Brazil), or Destiny® and Destiny® HC Adjuvant (Winfield United).

As such or in their formulations, the components (A) and (B) can also be used as a mixture with other agrochemically active ingredients for controlling unwanted plant growth, for example for controlling weeds or for controlling unwanted crop plants; finished formulations or tank mixes, for example, are possible.

Also possible are mixtures with other known active ingredients such as fungicides, insecticides, acaricides, nematicides, bird antifeedants, plant nutrients and soil improvers, and likewise with adjuvants and formulation assistants customary in crop protection.

The components (A) and (B) can be used as such, in the form of their formulations or the use forms prepared therefrom by further dilution, such as ready-to-use solutions, suspensions, emulsions, powders, pastes and granules. Application is typically accomplished, for example, by watering, sprinkling, spraying, broadcasting.

The components (A) and (B) can be deployed on the plants, plant parts or the area under cultivation (farmland), typically on the green plants and plant parts, and on the farmland. One means of application is the co-deployment of the active ingredients in the form of tank mixes, by mixing the optimally formulated concentrated formulations of the individual active ingredients together in the tank with water and deploying the spray liquor obtained.

For application, the formulations present in commercial form are optionally diluted in a customary manner, for example using water in the case of wettable powders, emulsifiable concentrates, dispersions and water-dispersible granules. Preparations in the form of dusts, granules for soil application or granules for broadcasting and sprayable solutions are usually not diluted further with other inert substances prior to application.

For application, a combination or composition according to the present invention comprising the components (A) and (B) as defined in the context of the present invention can be applied as a mixture having a fixed ratio between both partners (A) and (B) as described above, or as a mixture with variable ratios of components (A) and (B). The variable mixture ratio can be adapted to the actual field situation with spatial resolution, driven by recognition and automatic decision systems. The recognition system may recognize environmental factors on the field level, like weed species composition, weed growth stage, physical and chemical soil characteristics, crop health, growth stages or crop variety and weather conditions at, before and after application, geographical exposition and climatic zone of a spatial geography. The automatic decision system may take the environmental factors of a spatial geography into account to calculate the best application ratio of components (A) and (B) to achieve desired weed control, yield, environmental impact or cost effectiveness at a spatial field level. In addition, also contain one or more further components as described above, e.g. one or more further herbicides such as glyphosate, glufosinate, dicamba, 2,4-D, atrazine, or metribuzin, and/or one or more adjuvants such as MSO based products, for example rapeseed oil methyl ester, rapeseed oil ethyl ester, soybean oil methyl ester or soybean oil ethyl ester, optionally combined with one or more surfactants (e.g. high surfactant oil concentrate methylated soybean oil).

In view of the low damage caused by phenmedipham in corn, cotton and soybean, the present invention in a further aspect relates to the use of phenmedipham for controlling unwanted plants in crops of useful crop plants, wherein the useful crop plants are selected from the group consisting of corn, cotton, and soybean.

Typically, phenmedipham is used or applied early post-emergence or post-emergence of the unwanted plants.

Also typically, phenmedipham is used or applied early post-emergence or post-emergence of the useful crop plants selected from the group consisting of corn, cotton and soybean.

Phenmedipham is typically used at an application rate of from about 12.5 g/ha to about 300 g/ha, more typically at an application rate of from about 25 g/ha to about 250 g/ha, and even more typically at an application rate of from about 50 g/ha to about 200 g/ha.

### BIOLOGICAL EXAMPLES

Unless indicated otherwise, all amounts and percentages are by weight.

The meanings of the abbreviations are as follows:
PMP=Phenmedipham
MST=Mesotrione
TBT=Tembotrione
SCT=Sulcotrione
PMP was used as SC formulation type, commercially available as Betasana® (160 g PMP/L), from UPL, Germany
MST was used as SC formulation type, commercially available as Callisto® (480 g MST/L), from Syngenta, Germany
SCT was used as SC formulation type, commercially available as Mikado® (300 g SCT/L), from Dr. Stähler, Germany
TBT was used as WP formulation type, with 200 g TBT/kg, from Bayer, Germany

The respective (combinations of) materials were applied to weed plants in the greenhouse or in the field at the respective growth stage indicated hereinafter for the different weed species mentioned below. The respective (combinations of) active ingredients were also applied to corn, cotton and soybean crop plants, and the selectivity (damage) in these crop plants rated (assessed).

Visual scoring of the damage to the trial plants took place after the time mentioned in the respective Table—indicated in number of Days After Application (DAA). Damage and development of all above-ground parts of the respective plants was recorded. Visual rating was done on a percentage scale in relation to the untreated control (100%=all plants dead; 50%=green plant biomass reduced by 50%, and 0%=no discernible difference=like control plot).

The trials in the greenhouse were sprayed with an application volume of 300 L/ha with an automated track sprayer. The plots in the field were sprayed with an application volume of 140 L/ha with a hand held spray boom.

### Greenhouse Trials

In greenhouse selectivity trials and trials herbicidal activity trials against weed plants were investigated in post-emergence application of the respective material(s).

### Example 1—Greenhouse Selectivity Trials

Phenmedipham was applied at varying application rates (Dose Rate) to the crop plants of corn (Zea mays subsp. amylacea, ZEAMA), soybean (Glycine max, GLXMA) and cotton (Gossypium hirsutum, GOSHI) at a BBCH growth stage of the plants of BBCH 13 and the crop safety (crop injury, damage) assessed. The results are shown in Table 1 as the % damage when assessed 8 days after application (8 DAA).

TABLE 1
Greenhouse selectivity trials for PMP when applied
to corn, soybean or cotton plants (8 DAA)

| Active | Dose Rate | ZEAMA | GLXMA | GOSHI |
|---|---|---|---|---|
| ingredient | [g/ha] | (corn) | (soybean) | (cotton) |
| PMP | 12.5 | 0% | 2% | 0% |
| PMP | 25 | 0% | 3% | 0% |
| PMP | 75 | 7% | 0% | 3% |
| PMP | 125 | 0% | 5% | 6% |
| PMP | 200 | 15% | 18% | 6% |
| PMP | 300 | 30% | 20% | 14% |

In all the selectivity trials of Table 1 the adjuvant Mero® (rapeseed oil methyl ester) was added to the respective spray mixture in an amount corresponding to 1 L/ha.

Herbicidal activity—Weed control data:

Herbicidal activity against different weeds (undesired plants) was calculated as follows.

$${E}^{C} = A + B - A \times B / 100$$

wherein
A, B=respective value in percent of active ingredient A at a dose rate of a g/ha, ingredient B at a dose rate of b g/ha
E^{C}=Expected value according to Colby (S. R. Colby; Weeds 15 (1967), 20-22) in % at a dose rate of a+b, each in g/ha
Δ=Difference (in %) between measured value E and expected value E^{C} (%) (measured value minus expected value)

### Evaluation:

measured value E is greater than E^{C}:->synergism (+Δ)
measured value E is equal to E^{C}:->additive effect
measured value E is smaller than E^{C}:->antagonism (−Δ)

### Example 2—Greenhouse Weed Control Trials

The weed control activity of different (combinations of) materials was investigated in greenhouse trials for the following weed species:
STEME=Stellaria media
ECHCG=Echinochloa crus-galli
BROTE=Bromus tectorum

Phenmedipham amd Mesotrione were applied at varying application rates (Dose Rate) to the weed plant species STEME, ECHCG and BROTE. The results are shown in Tables 2a to 2c as the % control when assessed 25 days after application (25 DAA).

In all the trials of Table Tables 2a to 2c Mero® (rapeseed oil methyl ester) was added to the respective spray mixture in an amount corresponding to 1 L/ha for PMP, 1 L/ha for MST, and 2 L/ha for mixtures of PMP+MST.

TABLE 2a
Greenhouse weed control trials for PMP and MST in STEME, ECHCG
and BROTE, weight ratio MST:PMP = 1:1 assessed 25 DAA

| | Dose Rate | | | |
|---|---|---|---|---|
| Material | [g/ha] | STEME | ECHCG | BROTE |
| MST | 50 | 99% | 70% | 35% |
| PMP | 50 | 0% | 0% | 9% |
| MST + PMP | 50 + 50 | 100% | 85% | 70% |
| Δ= | | +1% | +15% | +29% |
| MST | 25 | 99% | 28% | 30% |
| PMP | 25 | 0% | 0% | 0% |
| MST + PMP | 25 + 25 | 100% | 70% | 30% |
| Δ= | | +1% | +42% | 0% |
| MST | 12.5 | 89% | 15% | 30% |
| PMP | 12.5 | 0% | 0% | 0% |
| MST + PMP | 12.5 + 12.5 | 92% | 50% | 30% |
| Δ= | | +3% | +35% | 0% |

TABLE 2b
Greenhouse weed control trials for PMP and
MST in STEME, ECHCG and BROTE, weight ratio
MST:PMP greater than 1:1 assessed 25 DAA

| | Dose Rate | | | |
|---|---|---|---|---|
| Material | [g/ha] | STEME | ECHCG | BROTE |
| MST | 75 | 99% | 70% | 40% |
| PMP | 50 | 0% | 0% | 9% |
| MST + PMP | 75 + 50 | 100% | 90% | 68% |
| Δ= | | +1% | +20% | +23% |
| MST | 25 | 99% | 28% | 30% |
| PMP | 12.5 | 0% | 0% | 0% |
| MST + PMP | 25 + 12.5 | 99% | 75% | 40% |
| Δ= | | 0% | +47% | +10% |
| MST | 75 | 99% | 70% | 40% |
| PMP | 25 | 0% | 0% | 0% |
| MST + PMP | 75 + 25 | 100% | 85% | 70% |
| Δ= | | +1% | +15% | +30% |
| MST | 75 | 99% | 70% | 40% |
| PMP | 12.5 | 0% | 0% | 0% |
| MST + PMP | 75 + 12.5 | 100% | 85% | 70% |
| Δ= | | +1% | +15% | +30% |

TABLE 2c
Greenhouse weed control trials for PMP and
MST in STEME, ECHCG and BROTE, weight ratio
PMP:MST greater than 1:1 assessed 25 DAA

| | Dose Rate | | | |
|---|---|---|---|---|
| Material | [g/ha] | STEME | ECHCG | BROTE |
| MST | 12.5 | 89% | 15% | 30% |
| PMP | 25 | 0% | 0% | 0% |
| MST + PMP | 12.5 + 25 | 99% | 55% | 33% |
| Δ= | | +10% | +40% | +3% |
| MST | 25 | 99% | 28% | 30% |
| PMP | 100 | 0% | 0% | 0% |
| MST + PMP | 25 + 100 | 100% | 50% | 40% |
| Δ= | | +1% | +22% | +10% |
| MST | 12.5 | 89% | 15% | 30% |
| PMP | 75 | 0% | 0% | 0% |
| MST + PMP | 25 + 100 | 100% | 60% | 30% |
| Δ= | | +11% | +45% | 0% |
| MST | 12.5 | 89% | 15% | 30% |
| PMP | 125 | 25% | 0% | 0% |
| MST + PMP | 12.5 + 125 | 100% | 60% | 40% |
| Δ= | | +8% | +45% | +10% |
| MST | 25 | 99% | 28% | 30% |
| PMP | 300 | 77% | 10% | 20% |
| MST + PMP | 25 + 300 | 100% | 80% | 60% |
| Δ= | | 0% | +45% | +16% |

### Examples 3 to 5—Field Trials

### Example 3—Field Trials with PMP and MST Against Different Weed Species

The growth stages of the different weed species are indicated according to the BBCH monograph “Growth stages of mono- and dicotyledonous plants”, 2^{nd} edition, 2001, ed. Uwe Meier, Federal Biological Research Centre for Agriculture and Forestry (Biologische Bundesanstalt für Land und Forstwirtschaft).

After the harmful plants had emerged, they were treated, at the respective growth stage indicated, with the respective materials as indicated at a water application rate of 140 L/ha.

After the treatment (21 or 35 days after application of the respective material), the herbicidal activity of respective material was scored visually at the same time by comparing the differently treated plots with the untreated control plots. The score figures of the different plots were averaged.

The dose rates of herbicidal ingredients used in each case are indicated for the respective active ingredient and refer to the amount of active ingredient per hectare (g/ha).

The weed control activity of different (combinations of) herbicidal active ingredients was investigated in field trials for the following weed species:
AMAVI=Amaranthus viridis
IPOAO=Ipomoea aristolochiaefolia
EPHHL=Euphorbia heterophylla
BIDPI=Bidens pilosa
BRADC=Brachiaria decumbens
ELEIN=Eleusine indica
CCHEC=Cenchrus echinatus

The growth stage of AMAVI was BBCH 13, the growth stage of IPOAO was BBCH 15, the growth stage of EPHHL was BBCH 13, the growth stage of BIDPI was BBCH 14, the growth stage of BRADC was BBCH 23, the growth stage of ELEIN was BBCH 11 and the growth stage of CCHEC was BBCH 12 at the time of application of the respective material.

Phenmedipham and Mesotrione were applied at varying application rates (Dose Rate) to the different species of weed plants. The results are shown in Tables 3a to 3e as the % control when assessed 21 and 35 days after application (DAA), respectively.

In all the trials of Tables 3a to 3e Mero® (rapeseed oil methyl ester) was added to the respective spray mixture in an amount corresponding to 1 L/ha for PMP, 1 L/ha for MST, and 2 L/ha for mixtures of PMP+MST.

TABLE 3a
Weed control field trials for PMP and MST
in AMAVI, IPOAO and EPHHL assessed 21 DAA

| | Dose Rate | | | |
|---|---|---|---|---|
| Material | [g/ha] | AMAVI | IPOAO | EPHHL |
| PMP | 75 | 0% | 0% | 0% |
| MST | 25 | 10% | 0% | 0% |
| PMP + MST | 75 + 25 | 50% | 100% | 50% |
| Δ= | | +40% | +100% | +50% |
| PMP | 100 | 0% | 0% | 0% |
| MST | 25 | 10% | 0% | 0% |
| PMP + MST | 100 + 25 | 47% | 100% | 50% |
| Δ= | | +37% | +100% | +50% |
| PMP | 125 | 0% | 0% | 0% |
| MST | 25 | 10% | 0% | 0% |
| PMP + MST | 125 + 25 | 47% | 92% | 50% |
| Δ= | | +37% | +92% | +50% |
| PMP | 250 | 0% | 0% | 0% |
| MST | 25 | 10% | 0% | 0% |
| PMP + MST | 250 + 25 | 50% | 96% | 52% |
| Δ= | | +40% | +96% | +52% |
| PMP | 75 | 0% | 0% | 0% |
| MST | 50 | 10% | 17% | 17% |
| PMP + MST | 75 + 50 | 47% | 100% | 80% |
| Δ= | | +37% | +83% | +63% |
| PMP | 100 | 0% | 0% | 0% |
| MST | 50 | 10% | 17% | 17% |
| PMP + MST | 100 + 50 | 47% | 100% | 68% |
| Δ= | | +37% | +83% | +51% |
| PMP | 125 | 0% | 0% | 0% |
| MST | 50 | 10% | 17% | 17% |
| PMP + MST | 125 + 50 | 47% | 100% | 77% |
| Δ= | | +37% | +83% | +60% |
| PMP | 250 | 0% | 0% | 0% |
| MST | 50 | 10% | 17% | 17% |
| PMP + MST | 250 + 50 | 47% | 100% | 73% |
| Δ= | | +37% | +83% | +56% |

TABLE 3b
Weed control field trials for PMP and MST
in AMAVI, IPOAO and EPHHL assessed 35 DAA

| | Dose Rate | | | |
|---|---|---|---|---|
| Material | [g/ha] | AMAVI | IPOAO | EPHHL |
| PMP | 75 | 0% | 0% | 0% |
| MST | 25 | 10% | 0% | 0% |
| PMP + MST | 75 + 25 | 50% | 100% | 43% |
| Δ= | | +40% | +100% | +43% |
| PMP | 100 | 0% | 0% | 0% |
| MST | 25 | 10% | 0% | 0% |
| PMP + MST | 100 + 25 | 47% | 100% | 40% |
| Δ= | | +37% | +100% | +40% |
| PMP | 125 | 0% | 0% | 0% |
| MST | 25 | 10% | 0% | 0% |
| PMP + MST | 125 + 25 | 47% | 92% | 27% |
| Δ= | | +37% | +92% | +27% |
| PMP | 250 | 0% | 0% | 0% |
| MST | 25 | 10% | 0% | 0% |
| PMP + MST | 250 + 25 | 43% | 96% | 33% |
| Δ= | | +33% | +96% | +33% |
| PMP | 75 | 0% | 0% | 0% |
| MST | 50 | 10% | 0% | 0% |
| PMP + MST | 75 + 50 | 47% | 100% | 80% |
| Δ= | | +37% | +100% | +80% |
| PMP | 100 | 0% | 0% | 0% |
| MST | 50 | 10% | 0% | 0% |
| PMP + MST | 100 + 50 | 47% | 100% | 68% |
| Δ= | | +37% | +100% | +68% |
| PMP | 125 | 0% | 0% | 0% |
| MST | 50 | 10% | 0% | 0% |
| PMP + MST | 125 + 50 | 47% | 100% | 77% |
| Δ= | | +37% | +100% | +77% |
| PMP | 250 | 0% | 0% | 0% |
| MST | 50 | 10% | 0% | 0% |
| PMP + MST | 250 + 50 | 47% | 100% | 73% |
| Δ= | | +37% | +100% | +73% |

TABLE 3c
Weed control field trials for PMP and
MST in BIDPI assessed 21 DAA and 35 DAA

| | Dose Rate | BIDPI | BIDPI |
|---|---|---|---|
| Material | [g/ha] | 21 DAA | 35 DAA |
| PMP | 75 | 0% | 0% |
| MST | 25 | 80% | 80% |
| PMP + MST | 75 + 25 | 86% | 92% |
| Δ= | | +6% | +12% |
| PMP | 100 | 0% | 0% |
| MST | 25 | 80% | 80% |
| PMP + MST | 100 + 25 | 93% | 93% |
| Δ= | | +13% | +13% |
| PMP | 125 | 0% | 0% |
| MST | 25 | 80% | 80% |
| PMP + MST | 125 + 25 | 92% | 92% |
| Δ= | | +12% | +12% |
| PMP | 250 | 0% | 0% |
| MST | 25 | 80% | 80% |
| PMP + MST | 250 + 25 | 100% | 100% |
| Δ= | | +20% | +20% |
| PMP | 75 | 0% | 0% |
| MST | 50 | 80% | 80% |
| PMP + MST | 75 + 50 | 91% | 91% |
| Δ= | | +11% | +11% |
| PMP | 100 | 0% | 0% |
| MST | 50 | 80% | 80% |
| PMP + MST | 100 + 50 | 80% | 80% |
| Δ= | | 0% | 0% |
| PMP | 125 | 0% | 0% |
| MST | 50 | 80% | 80% |
| PMP + MST | 125 + 50 | 100% | 100% |
| Δ= | | +20% | +20% |
| PMP | 250 | 0% | 0% |
| MST | 50 | 80% | 80% |
| PMP + MST | 250 + 50 | 100% | 100% |
| Δ= | | +20% | +20% |

TABLE 3d
Weed control field trials for PMP and MST
in BRADC, ELEIN and CCHEC assessed 21 DAA

| | Dose Rate | | | |
|---|---|---|---|---|
| Material | [g/ha] | BRADC | ELEIN | CCHEC |
| PMP | 75 | 0% | 0% | 0% |
| MST | 25 | 0% | 0% | 73% |
| PMP + MST | 75 + 25 | 40% | 27% | 27% |
| Δ= | | +40% | +27% | +27% |
| PMP | 100 | 0% | 0% | 0% |
| MST | 25 | 0% | 0% | 0% |
| PMP + MST | 100 + 25 | 37% | 30% | 33% |
| Δ= | | +37% | +30% | +33% |
| PMP | 125 | 0% | 0% | 0% |
| MST | 25 | 0% | 0% | 0% |
| PMP + MST | 125 + 25 | 32% | 33% | 20% |
| Δ= | | +32% | +33% | +20% |
| PMP | 250 | 0% | 0% | 0% |
| MST | 25 | 0% | 0% | 0% |
| PMP + MST | 250 + 25 | 30% | 33% | 30% |
| Δ= | | +30% | +33% | +30% |
| PMP | 75 | 0% | 0% | 0% |
| MST | 50 | 17% | 17% | 17% |
| PMP + MST | 75 + 50 | 50% | 30% | 32% |
| Δ= | | +33% | +13% | +15% |
| PMP | 100 | 0% | 0% | 0% |
| MST | 50 | 17% | 17% | 17% |
| PMP + MST | 100 + 50 | 52% | 32% | 32% |
| Δ= | | +35% | +15% | +15% |
| PMP | 125 | 0% | 0% | 0% |
| MST | 50 | 17% | 17% | 17% |
| PMP + MST | 125 + 50 | 45% | 30% | 30% |
| Δ= | | +28% | +13% | +13% |
| PMP | 250 | 0% | 0% | 0% |
| MST | 50 | 17% | 17% | 17% |
| PMP + MST | 250 + 50 | 40% | 32% | 32% |
| Δ= | | +23% | +15% | +15% |

TABLE 3e
Weed control field trials for PMP and MST
in BRADC, ELEIN and CCHEC assessed 35 DAA

| | Dose Rate | | | |
|---|---|---|---|---|
| Material | [g/ha] | BRADC | ELEIN | CCHEC |
| PMP | 75 | 0% | 0% | 0% |
| MST | 25 | 0% | 0% | 0% |
| PMP + MST | 75 + 25 | 23% | 27% | 27% |
| Δ= | | +23% | +27% | +27% |
| PMP | 100 | 0% | 0% | 0% |
| MST | 25 | 0% | 0% | 0% |
| PMP + MST | 100 + 25 | 20% | 27% | 30% |
| Δ= | | +20% | +27% | +30% |
| PMP | 125 | 0% | 0% | 0% |
| MST | 25 | 0% | 0% | 0% |
| PMP + MST | 125 + 25 | 23% | 23% | 17% |
| Δ= | | +23% | +23% | +17% |
| PMP | 250 | 0% | 0% | 0% |
| MST | 25 | 0% | 0% | 0% |
| PMP + MST | 250 + 25 | 23% | 30% | 20% |
| Δ= | | +23% | +30% | +20% |
| PMP | 75 | 0% | 0% | 0% |
| MST | 50 | 13% | 17% | 0% |
| PMP + MST | 75 + 50 | 20% | 20% | 7% |
| Δ= | | +7% | +3% | +7% |
| PMP | 100 | 0% | 0% | 0% |
| MST | 50 | 13% | 17% | 0% |
| PMP + MST | 100 + 50 | 23% | 22% | 30% |
| Δ= | | +10% | +5% | +30% |
| PMP | 125 | 0% | 0% | 0% |
| MST | 50 | 13% | 17% | 0% |
| PMP + MST | 125 + 50 | 27% | 30% | 30% |
| Δ= | | +14% | +13% | +30% |
| PMP | 250 | 0% | 0% | 0% |
| MST | 50 | 13% | 17% | 0% |
| PMP + MST | 250 + 50 | 23% | 32% | 32% |
| Δ= | | +10% | +15% | +32% |

### Example 4—Field Trials with PMP and an Aroylcyclohexanedione Herbicide Against Weed Species AMARE, KCHSC and PANRA

After the harmful plants had emerged, they were treated, at the respective growth stage indicated, with the respective materials as indicated at a water application rate of 187 L/ha.

After the treatment (15 days after the treatment), the herbicidal activity of respective material was scored visually at the same time by comparing the differently treated plots with the untreated control plots. The score figures of the different plots were averaged.

The dose rates of herbicidal ingredients used in each case are indicated for the respective active ingredient and refer to the amount of active ingredient per hectare (g/ha).

The weed control activity of different (combinations of) herbicidal active ingredients was investigated in field trials for the following weed species:
AMARE=Amaranthus retroflexus
KCHSC=Kochia scoparia
PANRA=Panicum ramosum

The growth stage of AMARE was BBCH 19, the growth stage of KCHSC was BBCH 19 and the growth stage of PANRA was BBCH 22 at the time of application of the respective material.

Phenmedipham and the respective aroylcyclohexanedione herbicide were applied at varying application rates (Dose Rate) to the different species of weed plants. The results are shown in Tables 4a to 4d as the % control when assessed 15 days after application (DAA), respectively.

In all the trials of Tables 4a to 4d Mero® (rapeseed oil methyl ester) was added to the respective spray mixture in an amount corresponding to 1 L/ha for PMP, 1 L/ha for the respective aroylcyclohexanedione herbicide, and 2 L/ha for mixtures of PMP+the respective aroylcyclohexanedione herbicide.

TABLE 4a
Weed control field trials for PMP and
MST in AMARE and KCHSC assessed 15 DAA

| | Dose Rate | | |
|---|---|---|---|
| Material | [g/ha] | AMARE | KCHSC |
| PMP | 150 | 0% | 0% |
| MST | 20 | 25% | 40% |
| PMP + MST | 150 + 20 | 40% | 45% |
| Δ= | | +15% | +5% |
| PMP | 150 | 0% | 0% |
| MST | 40 | 30% | 45% |
| PMP + MST | 150 + 40 | 45% | 50% |
| Δ= | | +15% | +5% |
| PMP | 150 | 0% | 0% |
| MST | 60 | 40% | 45% |
| PMP + MST | 150 + 60 | 55% | 50% |
| Δ= | | +15% | +5% |
| PMP | 150 | 0% | 0% |
| MST | 80 | 45% | 45% |
| PMP + MST | 150 + 80 | 60% | 50% |
| Δ= | | +15% | +5% |
| PMP | 150 | 0% | 0% |
| MST | 100 | 50% | 50% |
| PMP + MST | 150 + 100 | 75% | 65% |
| Δ= | | +25% | +15% |

TABLE 4b
Weed control field trials for PMP and
MST in AMARE and KCHSC assessed 15 DAA

| | Dose Rate | | |
|---|---|---|---|
| Material | [g/ha] | AMARE | KCHSC |
| PMP | 300 | 5% | 5% |
| MST | 20 | 25% | 40% |
| PMP + MST | 300 + 20 | 40% | 45% |
| Δ= | | +11% | +2% |
| PMP | 300 | 5% | 5% |
| MST | 40 | 30% | 45% |
| PMP + MST | 300 + 40 | 45% | 50% |
| Δ= | | +12% | +2% |
| PMP | 300 | 5% | 5% |
| MST | 60 | 40% | 45% |
| PMP + MST | 300 + 60 | 60% | 50% |
| Δ= | | +17% | +2% |
| PMP | 300 | 5% | 5% |
| MST | 80 | 45% | 45% |
| PMP + MST | 300 + 80 | 70% | 55% |
| Δ= | | +22% | +7% |
| PMP | 300 | 5% | 5% |
| MST | 100 | 50% | 50% |
| PMP + MST | 300 + 100 | 80% | 70% |
| Δ= | | +28% | +18% |

TABLE 4c
Weed control field trials for PMP and
TBT in AMARE and KCHSC assessed 15 DAA

| | Dose Rate | | |
|---|---|---|---|
| Material | [g/ha] | AMARE | KCHSC |
| PMP | 150 | 0% | 0% |
| TBT | 20 | 35% | 20% |
| PMP + TBT | 150 + 20 | 40% | 30% |
| Δ= | | +5% | +10% |
| PMP | 300 | 5% | 5% |
| TBT | 20 | 35% | 20% |
| PMP + TBT | 300 + 20 | 45% | 50% |
| Δ= | | +7% | +26% |

TABLE 4d
Weed control field trials for PMP and
SCT in AMARE and KCHSC assessed 15 DAA

| | Dose Rate | | |
|---|---|---|---|
| Material | [g/ha] | AMARE | KCHSC |
| PMP | 150 | 0% | 0% |
| SCT | 20 | 5% | 5% |
| PMP + SCT | 150 + 20 | 10% | 15% |
| Δ= | | +5% | +10% |
| PMP | 300 | 5% | 5% |
| SCT | 20 | 5% | 5% |
| PMP + SCT | 300 + 20 | 10% | 15% |
| Δ= | | 0% | +5% |

TABLE 4e
Weed control field trials for PMP and
MST or TBT in PANRA assessed 15 DAA

| | Dose Rate | |
|---|---|---|
| Material | [g/ha] | PANRA |
| PMP | 150 | 0% |
| MST | 20 | 15% |
| PMP + MST | 150 + 20 | 35% |
| Δ= | | +20% |
| PMP | 300 | 5% |
| MST | 20 | 15% |
| PMP + MST | 300 + 20 | 40% |
| Δ= | | +25% |
| PMP | 150 | 0% |
| TBT | 20 | 20% |
| PMP + TBT | 150 + 20 | 30% |
| Δ= | | +10% |
| PMP | 300 | 5% |
| TBT | 20 | 20% |
| PMP + TBT | 300 + 20 | 35% |
| Δ= | | +11% |

In the field trials of Tables 4a to 4e also the damage in soybean was assessed when PMP was applied to GLXMA at growth stage BBCH 14. The damage observed in each case was agronomically acceptable, i.e. below 15%.

### Example 5—Field Selectivity Trials

Phenmedipham and combinations of phenmedipham and mesotrione were applied at varying application rates (Dose Rate) to the crop plants of non-traited soybean (Glycine max, GLXMA) and corn (Zea mays, ZEAMX). The results are shown in Table 5 as the % damage when assessed 35 days after application (DAA), respectively.

In all the selectivity trials of Table 5 the adjuvant Mero® (rapeseed oil methyl ester) was added to the respective spray mixture in an amount corresponding to 1 L/ha for PMP, 1 L/ha for MST, and 2 L/ha for mixtures of PMP+MST.

The herbicidal effects observed for the herbicide(s) are indicated in % activity against the respective weed. The % damage (injury) indicated refers to the maximum damage observed.

TABLE 5
Field selectivity trials for soybean
assessed 35 DAA - maximum damage in %

| | Dose Rate | GLXMA | ZEAMX |
|---|---|---|---|
| Material | [g/ha] | 35 DAA | 35 DAA |
| PMP | 75 | 10% | 6% |
| MST | 25 | 12% | 0% |
| PMP + MST | 75 + 25 | 19% | 0% |
| PMP | 125 | 15% | 6% |
| MST | 25 | 12% | 0% |
| PMP + MST | 125 + 25 | 24% | 0% |
| PMP | 250 | 14% | 6% |
| MST | 25 | 12% | 0% |
| PMP + MST | 250 + 25 | 31% | 0% |
| PMP | 75 | 10% | 6% |
| MST | 50 | 29% | 0% |
| PMP + MST | 75 + 50 | 40% | 0% |
| PMP | 125 | 15% | 6% |
| MST | 50 | 29% | 0% |
| PMP + MST | 125 + 50 | 29% | 0% |
| PMP | 250 | 14% | 6% |
| MST | 50 | 29% | 0% |
| PMP + MST | 250 + 50 | 32% | 0% |

For additional illustration, further and preferred embodiments of the present invention are set forth below.

Embodiment 1 is a herbicidal combination, wherein the active herbicidal ingredients in said combination comprise or consist of
(A) phenmedipham, and
(B) one or more aroylcyclohexanedione herbicides.

Embodiment 2 is the herbicidal combination according to Embodiment 1, wherein the ratio by weight of the total amount of component (A) to the total amount of component (B) is in the range of from about 25:1 to about 1:20, preferably is in the range of from about 20:1 to about 1:15, and more preferably in the range of from about 15:1 to about 1:15.

Embodiment 3 is the herbicidal combination according to Embodiment 1, wherein the ratio by weight of the total amount of component (A) to the total amount of component (B) is in the range of from about 15:1 to about 1:5.

Embodiment 4 is the herbicidal combination according to any one of Embodiments 1 to 3, wherein the ratio by weight of the total amount of component (A) to the total amount of component (B) is greater than 1:1.

Embodiment 5 is the herbicidal combination according to Embodiment 1, wherein the ratio by weight of the total amount of component (A) to the total amount of component (B) is in the range of from about 12:1 to about 5:4, preferably is in the range of from about 10:1 to about 3:2.

Embodiment 6 is the herbicidal combination according to any one of Embodiments 1 to 5, wherein component (B) comprises or consists of one or more aroylcyclohexanedione herbicides selected from the group consisting of benquitrione, dioxopyritrione, fenquinotrione, ketospiradox, lancotrione, mesotrione, quintrione, sulcotrione, tefuryltrione, or tembotrione, and mixtures thereof.

Embodiment 7 is the herbicidal combination according to any one of Embodiments 1 to 5, wherein component (B) comprises or consists of one or more aroylcyclohexanedione herbicides selected from the group consisting of mesotrione, sulcotrione, or tembotrione, and mixtures thereof.

Embodiment 8 is the herbicidal combination according to any one of Embodiments 1 to 5, wherein component (B) comprises or consists of mesotrione.

Embodiment 9 is the herbicidal combination according to any one of Embodiments 1 to 8, wherein the herbicidal combination additionally comprises one or more further constituents selected from the group consisting of further herbicides, water, formulation adjuvants, and safeners.

Embodiment 10 is the herbicidal combination according to any one of Embodiments 1 to 9, wherein the herbicidal combination additionally comprises one or more formulation adjuvants, preferably one or more alkyl esters.

Embodiment 11 is the herbicidal combination according to any one of Embodiments 1 to 9, wherein the herbicidal combination additionally comprises one or more formulation adjuvants selected from the group consisting of rapeseed oil methyl ester, rapeseed oil ethyl ester, soybean oil methyl ester and soybean oil ethyl ester, and mixtures thereof.

Embodiment 12 is the herbicidal combination according to any one of Embodiments 1 to 11, wherein the herbicidal combination is a composition in the form of a concentrated formulation or a ready-to-use diluted spray application mixture (tank-mix).

Embodiment 13 is a method for controlling weed plants in crops of useful plants, characterized in that a herbicidal combination according to any one of Embodiments 1 to 12 is applied to the weed plants, plants, plant seeds, or to the area on which the weed plants are growing.

Embodiment 14 is the use of a herbicidal combination according to any one of Embodiments 1 to 12 for controlling unwanted plants in crops of useful plants.

Embodiment 15 is the method or use according to Embodiments 13 or 14, characterized in that the crop plants are selected from the group consisting of corn, cotton, and soybean.

Embodiment 16 is the method or use according to any one of Embodiments 13 to 15, characterized in that the crop plants have been genetically modified.

Embodiment 17 is the method or use according to any one of Embodiments 13 to 16, characterized in that it is carried out pre-emergence, early post-emergence or post-emergence, preferably early post-emergence or post-emergence.

Embodiment 18 is the method or use according to any one of Embodiments 13 to 17, characterized in that
component (A) is used at an application rate of at least about 12.5 g/ha
and/or
component (B) at an application rate of at least about 12.5 g/ha.

Embodiment 19 is the method or use according to any one of Embodiments 13 to 18, characterized in that
component (A) is used at an application rate of from about 12.5 g/ha to about 400 g/ha
and/or
component (B) at an application rate of from about 12.5 g/ha to about 300 g/ha.

Embodiment 20 is the method or use according to any one of Embodiments 13 to 19, characterized in that
component (A) is used at an application rate of from about 25 g/ha to about 300 g/ha
and/or
component (B) at an application rate of from about 12.5 g/ha to about 250 g/ha.

Embodiment 21 is the method or use according to any one of Embodiments 13 to 20, characterized in that
component (A) is used at an application rate of from about 25 g/ha to about 250 g/ha
and/or
component (B) at an application rate of from about 25 g/ha to about 200 g/ha.

Embodiment 22 is the method or use according to any one of Embodiments 13 to 21, characterized in that
component (A) is used at an application rate of from about 50 g/ha to about 200 g/ha
and/or
component (B) at an application rate of from about 25 g/ha to about 150 g/ha.

Embodiment 23 is the method or use according to any one of Embodiments 13 to 22, wherein the active herbicidal ingredients (A) and (B) are applied sequentially.

Embodiment 24 is the method or use according to any one of Embodiments 13 to 22, wherein the active herbicidal ingredients (A) and (B) are applied together as a single composition.

Embodiment 25 is the use of phenmedipham for controlling unwanted plants in crops of useful crop plants, wherein the useful crop plants are selected from the group consisting of corn, cotton and soybean.

Embodiment 26 is the use according to Embodiment 25, wherein phenmedipham is applied early post-emergence or post-emergence of the unwanted plants.

Embodiment 27 is the use according to Embodiment 25 or 26, wherein phenmedipham is applied early post-emergence or post-emergence of the useful crop plants.

Embodiment 28 is the use according to any one of Embodiments 25 to 27, wherein phenmedipham is applied early post-emergence or post-emergence of the unwanted plants and early post-emergence or post-emergence of the useful crop plants.

Embodiment 29 is the use according to any one of Embodiments 25 to 28, wherein phenmedipham is used at an application rate of from about 12.5 g/ha to about 300 g/ha.

Embodiment 30 is the use according to any one of Embodiments 25 to 28, wherein phenmedipham is used at an application rate of from about 25 g/ha to about 250 g/ha.

Embodiment 31 is the use according to any one of Embodiments 25 to 28, wherein phenmedipham is used at an application rate of from about 50 g/ha to about 200 g/ha.

Example embodiments have been provided so that this disclosure will be thorough, and will fully convey the scope to those who are skilled in the art. Numerous specific details are set forth such as examples of specific components, methods, etc. to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes and well-known technologies are not described in detail.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, seeds, members and/or sections, these elements, components, seeds, members and/or sections should not be limited by these terms. These terms may be only used to distinguish one element, component, seed, member or section from another element, component, seed, member or section. Terms such as “first,” “second,” and other numerical terms when used herein do not imply a sequence or order unless clearly indicated by the context. Thus, a first element or component could be termed a second element or component without departing from the teachings of the example embodiments.

As various changes could be made in the above compositions and methods without departing from the scope of the present disclosure, it is intended that all matter contained in the above description shall be interpreted as illustrative and not in a limiting sense.

Having described the present disclosure in detail, it will be apparent that modifications and variations are possible without departing from the scope of the present disclosure defined in the appended claims.

1. An herbicidal combination comprising a plurality of active herbicidal ingredients, wherein the plurality of active herbicidal ingredients in the combination comprises:
phenmedipham; and
one or more aroylcyclohexanedione herbicides.

2. The herbicidal combination according to claim 1, wherein a ratio by weight of a total amount of phenmedipham to a total amount of the one or more aroylcyclohexanedione herbicides is in a range of from about 25:1 to about 1:20.

3. The herbicidal combination according to claim 2, wherein the ratio by weight of the total amount of phenmedipham to the total amount of the one or more aroylcyclohexanedione herbicides is in the range of from about 15:1 to about 1:15.

4. The herbicidal combination according to claim 3, wherein the ratio by weight of the total amount of phenmedipham to the total amount of the one or more aroylcyclohexanedione herbicides is in the range of from about 12:1 to about 1:12.

5. The herbicidal combination according to claim 1, wherein the one or more aroylcyclohexanedione herbicides comprises aroylcyclohexanedione herbicides selected from the group consisting of benquitrione, dioxopyritrione, fenquinotrione, ketospiradox, lancotrione, mesotrione, quintrione, sulcotrione, tefuryltrione, or tembotrione, and mixtures thereof.

6. The herbicidal combination according to claim 5, wherein the one or more aroylcyclohexanedione herbicides comprises aroylcyclohexanedione herbicides selected from the group consisting of mesotrione, sulcotrione, or tembotrione, and mixtures thereof.

7. The herbicidal combination according to claim 1, wherein the herbicidal combination additionally comprises one or more further constituents selected from the group consisting of further herbicides, water, formulation adjuvants, and safeners.

8. The herbicidal combination according to claim 1, wherein the herbicidal combination is a concentrated formulation or a ready-to-use diluted spray application mixture.

9. A method for controlling weed plants in crops of useful plants, the method comprising applying the herbicidal combination according to claim 1 to the weed plants, plants, plant seeds, or to the area on which the weed plants are growing.

10. (canceled)

11. The method according to claim 9, wherein the crop plants are selected from the group consisting of corn, cotton, and soybean.

12. The method according to claim 9, wherein the method is carried out during one of pre-emergence, early post-emergence and post-emergence of the crops of useful plants.

13. The method according to claim 9, wherein phenmedipham is applied at an application rate of from about 12.5 g/ha to about 400 g/ha and/or the one or more aroylcyclohexanedione herbicides is applied at an application rate of from about 12.5 g/ha to about 300 g/ha.

14. A method for controlling unwanted plants in crops of useful crop plants, the method comprising applying phenmedipham to the unwanted plants, wherein the useful crop plants are selected from the group consisting of corn, cotton and soybean.

15. The method according to claim 14, wherein phenmedipham is applied during one of early post-emergence and postemergence of the unwanted plants.

16. The herbicidal combination according to claim 2, wherein the ratio by weight of the total amount of phenmedipham to the total amount of the one or more aroylcyclohexanedione herbicides is in the range of from about 20:1 to about 1:15.

17. The method according to claim 12, wherein the method is carried out during one of early post-emergence and post-emergence of the crops of useful plants.

18. The method according to claim 14, wherein phenmedipham is applied during one of early post-emergence and post-emergence of the useful crop plants.
